(19) United States
(12) Patent Application Publication
(10) Pub. No.: US 2006/0237058 A1
(43) Pub. Date: Oct. 26, 2006

(54) Direct current combiner box with power monitoring, ground fault detection and communications interface

(76) Inventors: Ronald Bradley McClintock, Novato, CA (US); Leif Ronnie Pettersson, Novato, CA (US)

Correspondence Address: STEVEN A. NIELSEN;ALLMAN & NIELSEN, P.C, 100 Larkspur Landing Circle, Suite 212, LARKSPUR, CA, 94939, US

(21) Appl. No.: 11/379,728

(22) Filed: Apr. 21, 2006

Related U.S. Application Data
(60) Provisional application No. 60/673,991, filed on Apr. 25, 2005.

(51) Int. Cl. H02N 6/00

(52) U.S. Cl. 136/244

(57) ABSTRACT

A combiner box is used to collect direct current from solar panels or other energy sources. The combiner box integrates all means necessary for ground fault detection, current monitoring, voltage monitoring, and power monitoring. The combiner box may include a communication interface suitable for Web enabled monitoring, electronic notifications of system status, and/or remote control of system functions. In one embodiment, the combiner box uses integrated circuits and printed circuit board technology to achieve new efficiencies in manufacturing, installation and system analysis at the string level. A separate hand piece may be used by installers to test the performance of the combiner box, installation of the solar panels, performance of the solar panels and connections between the solar panels and the combiner box.

### CROSS-REFERENCE TO RELATED APPLICATIONS

This application claims the benefit of the filing of U.S. Provisional Patent Application Ser. No. 60/673,991 entitled “Direct Current Combiner Box with Power Monitoring, Ground Fault Detection, and Communications Interface”, filed on Apr. 25, 2005, and the specification and all parts thereof are incorporated herein by reference.

### FIELD OF THE INVENTION

The present invention relates to the use and construction of combiner boxes suitable for collection of direct current generated by photovoltaic cell panels (solar panels) and other energy sources. The present invention allows for ground fault detection, remote monitoring and control of system status at a system level and/or for each string of direct current entering the combiner box. Optional data processing circuitry may be installed within the disclosed combiner box and an optional hand piece may be used to check system status and installation.

### DESCRIPTION OF THE RELATED ART

U.S. Pat. No. 6,930,868 by Kondo (the '868 patent) discloses a solar power generation method where ground fault detection occurs after strings of DC power are aggregated. Ground fault detection occurs at the DC/AC inverter where an AC leakage component is calculated. One string of DC current in a ground fault state will stop all power generation at the DC/AC inverter. The '868 patent fails to provide system analysis or ground fault detection for any particular string of solar panels entering the power collection system. The '868 patent discloses an inefficient method of ground fault detection as one string of solar panels in a ground fault state will “tie up” the entire system and waste the power generated by the remaining strings of solar panels. The '868 patent does not provide means to quickly ascertain which string is in a ground fault state.

U.S. Pat. No. 6,713,890 by Kondo (the '890 patent) discloses a power generator that disconnects power at a point after the DC/AC inverter. A moving part disconnects in the event of a ground fault. Disconnection status requires a visual inspection of each DC/AC inverter ground fault switch and physical manipulation to reset the system. As separate DC/AC inverters and disconnection switches are used for each DC input, no consolidation of components is possible.

The '890 patent relies upon complex analysis of AC leakage current and current filters. The '890 patent fails to disclose means of measuring DC current directly and requires separate DC/AC inverters and physical switches for each DC power input or string of solar panels.

U.S. Pat. No. 6,624,350 by Nixon, (the '350 patent) discloses a solar power management system that checks for polarity at each input of DC power and provides visual indications of polarity. The '350 patent does not provide means of monitoring ground fault status for each input of DC power, thus, a ground fault from one DC power input halts the entire system.

### SUMMARY OF THE INVENTION

The present invention overcomes shortfalls in the related art by providing a new combiner box to economically and efficiently monitor and isolate individual strings or circuits of DC power. Each string of DC power has a negative component attached to the negative bus of the combiner box and a positive component attached to the positive bus of the combiner box. At or near either bus, integrated circuitry is used to monitor and report current, current differential and power for each entering string or circuit of DC power. Integrated circuitry may, if necessary, shut off individual strings of DC input, allowing the other inputs to continue power production through the combiner box.

The present invention overcomes shortfalls in the '868 patent by analyzing current differentials directly and in proximity to the positive and negative bus, before current reaches an inverter. Thus, the present invention does not require the use of extra hardware to factor out current leakage from a DC/AC inverter. The present invention consolidates ground fault detection and other needed functions by use of a single combiner box that accommodates, controls and reports on individual strings of DC current.

The present invention overcomes shortfalls in the '890 patent by controlling input to the combiner box at the string level. In the present invention, if one string is in a ground fault state, the remaining strings still contribute power to the combiner box and energy generation continues. The '890 patent discloses a switch the shuts down all power to an inverter in the event of a ground fault.

The present invention overcomes shortfalls in the '350 patent by providing ground fault detection and ground fault interruption at the string level. Any ground fault occurring in the system disclosed in the '350 patent shuts down the entire system.

The disclosed combiner box allows for continuous monitoring of system performance so that problems such as poor connections or sub-standard photovoltaic cell panels may be detected and repaired before causing a ground fault or decreases in current. The disclosed invention monitors and reports gradual or sudden changes in current, so that repairs may be made to keep power and income generation maximized. By monitoring and controlling direct current circuits at the string level, significant time is saved by pin pointing poorly performing strings.

In large commercial applications multiple photovoltaic cell panels may be connected in series to compose a string that is attached to the combiner box. Each string or circuit is attached to the negative and positive bus in parallel. The use of integrated circuits within the combiner box removes the need for expensive and bulky transducers at each string.

The artful design of the disclosed combiner box adds direct current monitoring capability in a compact form that saves time in installation. The prior art required a separate control unit to be wired to and through the combiner box. Such wiring added complexity, expense and the potential for errors in the installation of solar power systems.

The use of a printed circuit board allows for flush mounting into the combiner box. An installer merely places the connections from the solar panels into either side of the combiner box. All monitoring circuitry in integrated into the printed circuit board.

An optional hand piece may be inserted into the disclosed combiner box by the installer to check current, current differential, power and other information for each string. The ability of the combiner box to accept a diagnostic hand piece allows for quick, in the field analysis of system performance. An installer may quickly pin point installation problems at the string level. The ability to accept a diagnostic hand piece allows for the use of combiner boxes without the optional “head unit” described below.

An optional controller or “head unit” may be installed within the disclosed combiner box to allow for local or remote reporting of diagnostic analysis and system information. The optional controller includes means of transmitting system status over the Internet using standard protocols and means for remotely monitoring and controlling overall system functions and individual strings or circuits. Users may receive system information and remotely control system functions by various means including cell phones, PDAs, or computers with Internet access.

### BRIEF DESCRIPTION OF THE SEVERAL VIEWS OF THE DRAWINGS

FIG. 1 is a schematic diagram of the combiner box.

FIG. 2 is a schematic diagram of the combiner box with the optional communications module.

FIG. 3 is a block diagram of numerous combiner boxes powering one inverter.

### DETAILED DESCRIPTION

The following detailed description is directed to certain specific embodiments of the invention. However, the invention can be embodied in a multitude of different ways as defined and covered by the claims. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

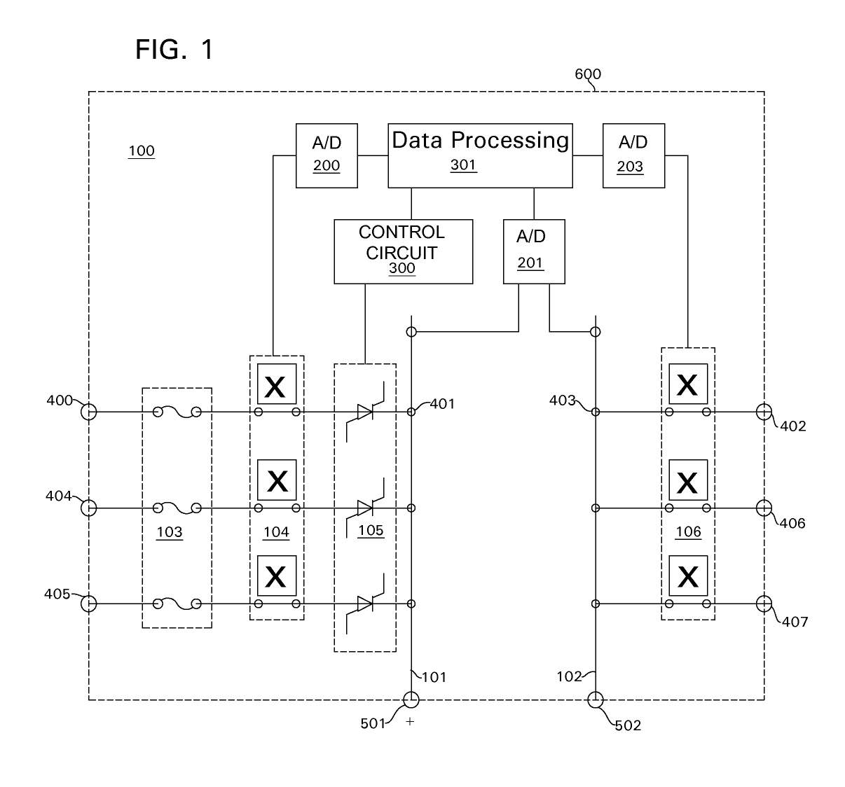

100 of FIG. 1 shows the disclosed combiner box with three input DC circuits, however, additional or fewer circuits may be disposed within the combiner box. 600 is the perimeter of the combiner box.

400 is the positive connection point for a DC power source such as a solar cell. Along the same circuit is a bank of fuses 103, bank of DC current sensors 104, bank of controlled switches 105, and the positive bus 101 at connection point 401.

The negative connection point for the first input DC circuit or string starts at 402 passes through DC current sensor block 106 and connects to the negative bus 102 at connection point 403.

The second string of positive DC input may enter at 404. The second string of negative DC input may enter at 406. The third string of positive DC input may enter at 405. The third string of negative DC input may enter at 407. Additional strings of DC input may be added to the combiner box.

An inverter or other load may be connected to the positive output 501 and negative output at 502.

Integrated control circuit blocks 104 and 106 measure string currents and convert the currents into proportional voltages.

Analog to digital converter 200 receives voltages from the 104 block of integrated control circuits. Analog to digital converter 203 receives voltages from the 106 block of integrated control circuits. Analog to digital converter 201 receives a voltage potential from the negative bus 102 and positive bus 101. Analog to digital converters 200, 201 and 203 accept voltages and convert the voltages into proportional digital values. The proportional digital values from converters 200, 201 and 203 enter the data processing unit 301.

Data processing unit 301 monitors total current for each string, current differential for each string, voltage, and system status. Data processing unit 301 has means to utilize computer software and means to provide input to control circuit 300. Control circuit 300 has means to control all switches in the 105 block. Each switch in the 105 block is controlled on an individual basis allowing for example ground fault interruption on a string by string basis.

In an alternative embodiment A/D converters 200, 201, 203, control circuit unit 300, and data processing unit 301 are not originally supplied with the combiner box 100, but may be installed subsequently as an upgrade as an optional “head unit”.

In this alternative embodiment, the combiner box 100 may accept an optional diagnostic hand piece that reports system status, status for each string and other data useful for testing system performance and diagnosis of possible installation problems.

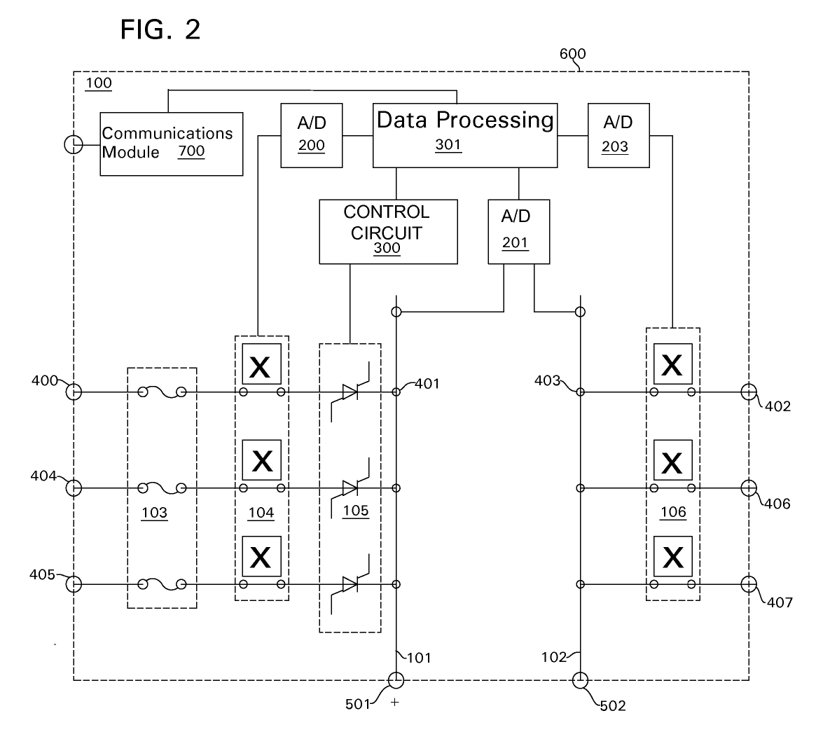

FIG. 2 shows the disclosed combiner box 100 with the optional communications module 700 which sends and receives information to and from the data processing unit 301. The communications module 700 has means to transmit and receive signals through standard network protocols. Communications module 700 allows remote users to monitor system performance and control system functions. Remote users may access the system through PDA's, cell phones, the Internet, or other methods.

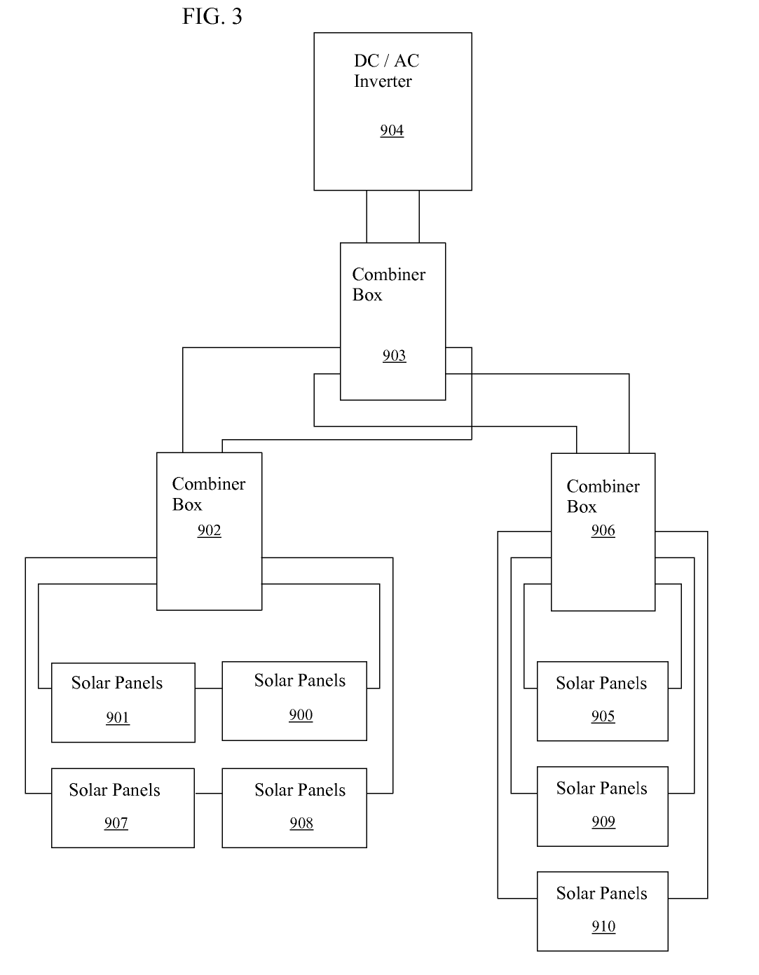

FIG. 3 shows a possible combination of solar panels and combiner boxes configured to supply power to a DC/AC inverter 904 or other load. Solar panels 900 are connected in series to solar panels 901. Together, solar panels 900 and 901 are connected as one string or circuit of DC input to combiner box 902.

Solar panels 907 and 908 are connected in series and together are connected as one string or circuit of DC input to combiner box 902.

The output of combiner box 902 is connected as a string or circuit of DC input to combiner box 903 which supplies power to the DC/AC inverter 904.

Solar panels 905, 909, and 910 are connected to combiner box 906 as separate strings of DC input. The output of combiner box 906 enters combiner box 903 as a string or circuit of DC input. Combiner box 903 supplies power to the DC/AC inverter 904.

What is claimed is:

1. An apparatus for combining and monitoring each string of entering direct current comprising:
means for detecting current in one or more strings of entering direct current; and
means of combining direct current entering the apparatus.

2. The apparatus of claim 1 with means of monitoring power in one or more strings of direct current.

3. The apparatus of claim 1 with means of communicating system status.

4. The apparatus of claim 1 with means to perform remote diagnostics upon the apparatus.

5. The apparatus of claim 1 with means to detect ground faults by comparisons of the positive and negative components of each entering string of direct current.

6. The apparatus of claim 5 with means of using computer software to analyze the positive and negative components of each entering string of direct current.

7. The apparatus of claim 1 using one or more integrated circuits to analyze each string of direct current entering the apparatus.

8. The apparatus of claim 7 with means to discontinue input from any string that has reached a ground fault state.

9. The apparatus of claim 1 wherein a direct current measurement is converted into a proportional voltage value.

10. The apparatus of claim 9 wherein the proportional voltage value is converted into a proportional digital value.

11. The apparatus of claim 10 wherein the analog to digital conversion occurs for each entering string of direct current.

12. The apparatus of claim 11 using integrated printed circuit board components.

13. The apparatus of claim 12 wherein the digital signals may be remotely monitored.

14. The apparatus of claim 13 wherein system functions may be remotely controlled.

15. The apparatus of claim 1 with means to accept a separate communication apparatus.

16. The apparatus of claim 15 wherein the attached communication apparatus has means of communicating system status.

17. The apparatus of claim 1 with means to accept a separate data processing unit.

18. The apparatus of claim 1 with means to accept a separate testing apparatus.

19. A method of combining and monitoring strings of direct current entering a single apparatus comprising the steps of:
attaching to the apparatus a positive and a negative component from each string of direct current;
using integrated circuits to measure the current from each string; and
using a positive bus and a negative bus to collect power from each string of direct current.

20. The method of claim 19 wherein the direct current measurement is converted into a proportional voltage measurement which is in turn converted into a proportional digital value.

21. The method of claim 20 wherein a hand piece is attached to the apparatus to test the installation and performance of the apparatus.

22. The method of claim 20 wherein a data processing unit is attached to the apparatus.

23. The method of claim 22 wherein a communication component is used to transmit information regarding each string of direct current.

24. The method of claim 23 wherein the communication component may be used to remotely control the system.
